(19) United States
(12) Patent Application Publication
(10) Pub. No.: US 2024/0339229 A1
(43) Pub. Date: Oct. 10, 2024

(54) Coaxial Cylindrical D-D Neutron Generator Based on Inertial Electrostatic

(71) Applicant: Lanzhou University, Lanzhou, Gansu (CN)

(72) Inventors: Zheng WEI, Lanzhou, Gansu (CN); Zeen YAO, Lanzhou, Gansu (CN); Yu ZHANG, Lanzhou, Gansu (CN); Junrun WANG, Lanzhou, Gansu (CN)

(21) Appl. No.: 18/500,031

(22) Filed: Nov. 1, 2023

(30) Foreign Application Priority Data
Apr. 10, 2023 (CN) 202310371386.6

(51) Int. Cl. G21B 1/03; G21B 1/17

(52) U.S. Cl. CPC G21B 1/03; G21B 1/17

(57) ABSTRACT

Disclosed is a coaxial cylindrical D-D neutron generator based on inertial electrostatic confinement fusion, falling within the technical field of neutron generators. A housing, a grid anode, a grid cathode, a high-voltage connector assembly and an observation window are included. One end of the housing is connected to the high-voltage connector assembly, and the observation window is arranged at the other end of the housing; and a low-pressure cavity is arranged at an interior of the housing, the grid anode and the grid cathode are mounted in the low-pressure cavity and electrically connected to a high-voltage connector, and an interior of the low-pressure cavity is filled with deuterium gas. The neutron generator of the present disclosure features simple structure, long service life, simple maintenance and low cost, which can meet the requirements of reactor ignition, nuclear material detection and nondestructive detection of aerospace components for miniaturized neutron generators.

### CROSS-REFERENCE TO RELATED APPLICATIONS

This application claims priority of Chinese Patent Application No. 202310371386.6, filed on Apr. 10, 2023, the entire contents of which are incorporated herein by reference.

### TECHNICAL FIELD

The present disclosure relates to the technical field of neutron generators, in particular to a coaxial cylindrical D-D neutron generator based on inertial electrostatic confinement fusion.

### BACKGROUND

A neutron source is an important apparatus for developing neutron application technologies such as neutron photography, neutron activation analysis and neutron explosive detection, which has important application value in reactor ignition, nuclear material detection, nondestructive detection of aerospace components (such as aero-engine blades, spacecraft and missile ignition apparatuses) and anti-terrorism. Neutron sources mainly include a reactor neutron source, an isotope neutron source and an accelerator neutron source.

The reactor neutron source utilizes nucleus to release fission neutrons during fission. The reactor neutron source has extremely high neutron flux, which is incomparable to all other isotope neutron source and general accelerator neutron source. Because of its high neutron flux, the reactor neutron source is mostly used in radiation effect research and isotope production. However, the reactor neutron source has the disadvantages of complex neutron energy spectrum, complicated apparatus structure and poor radiation safety performance, which restricts the application of the reactor neutron source in neutron application technology.

The isotope neutron source usually generates neutrons by nuclear reactions such as (α, n), (γ, n) and spontaneous fission. Compared with the reactor neutron source and the accelerator neutron source, the isotope neutron source has the advantages of small volume and easy operation, but has the disadvantages of poor radiation safety performance, low neutron yield, limited import and high cost.

The accelerator neutron source usually generates neutrons by (p, n) and (d, n) nuclear reactions. The (p, n) reaction usually has a reaction threshold, which is not suitable for a miniaturized neutron source device. On the contrary, almost all (d, n) nuclear reactions for obtaining neutrons are strongly exothermic, there is no threshold for the reaction, and the deuterons with energy close to zero can produce neutrons. Most accelerator neutron sources use the deuterons as bombarding particles, which performs (d, n) nuclear reaction with light nuclide target nucleus to obtain neutrons. The target nucleuses that are widely used are ²H, ³H, ⁷Li and ⁹Be, among which the first two reactions emit mono-energetic neutrons, while the latter two neutrons have complex energy spectrum, and because ³H is a controlled nuclear material and its price is extremely expensive, D-D fusion reaction is often used to provide mono-energetic neutrons. Currently, a double voltage D-D neutron generator and a compact D-D neutron generator developed in the laboratory are difficult to be directly applied to the neutron application technology field due to the limitations of huge system, high power and limited target life. A compact, miniaturized and high-yield neutron source has become the main bottleneck technologically that limits the application of current neutron application technology.

### SUMMARY

A main objective of the present disclosure is to provide a coaxial cylindrical D-D neutron generator based on inertial electrostatic confinement fusion, which can meet the requirements of reactor ignition, nuclear material detection and nondestructive detection of aerospace components for miniaturized neutron generators.

In order to achieve the above objective, the present disclosure provides a coaxial cylindrical D-D neutron generator based on inertial electrostatic confinement fusion, including a housing, a grid anode, a grid cathode, a high-voltage connector assembly and an observation window. One end of the housing is connected to the high-voltage connector assembly, and the observation window is arranged at the other end of the housing; and a low-pressure cavity is arranged at an interior of the housing, the grid anode and the grid cathode are mounted in the low-pressure cavity, the grid anode is grounded, the grid cathode is electrically connected to a high-voltage power supply through a high-voltage connector, and an interior of the low-pressure cavity is filled with deuterium gas.

Further, a molecular pump interface is arranged on the housing and connected to a molecular pump through a loose flange for pumping air in the low-pressure cavity.

Further, a vacuum gauge interface is arranged on the housing and connected to a vacuum gauge through the loose flange for measuring a vacuum degree in the low-pressure cavity.

Further, an air inlet is arranged on the housing, and a pipe communicating with a deuterium gas source is arranged at the air inlet.

Further, a flow valve is arranged on the pipe and electrically connected to a flow controller for accurately controlling the air intake amount.

Further, the housing has a length of 600 mm, an outer wall diameter of 110 mm, and a wall thickness of 3 mm.

Further, the grid anode is annularly arranged on a disc with a radius of 45.5 mm by 24 stainless steel columns, and each of the stainless steel columns has a length of 300 mm and a diameter of 3 mm.

Further, the grid cathode is annularly arranged on a disc with a radius of 11.5 mm by 12 stainless steel columns, and each of the stainless steel columns has a length of 200 mm and a diameter of 3 mm.

Further, the high-voltage connector assembly includes a ceramic insulating ring, a high-voltage cable, cooling pipes and stainless steel flanges. The high-voltage cable is configured to feed negative high voltage to the grid cathode, the cooling pipes are wrapped around the high-voltage cable, the ceramic insulating ring is wrapped around the cooling pipes, and the stainless steel flanges are mounted outside the ceramic insulating ring.

The present disclosure has the following beneficial effects.

The present disclosure provides a coaxial cylindrical D-D neutron generator based on inertial electrostatic confinement fusion. A high-density D+ ion region is formed around the grid cathode by glow discharge, and D+ ions interact with D+ ions to generate a D (d, n)³He (D-D) fusion reaction, thus generating a high-yield fast neutron field. Because the apparatus has no target structure and no cooling system, the apparatus has the advantages of simple structure, long service life, simple maintenance and low cost. The present disclosure relates to a coaxial cylindrical D-D neutron generator based on inertial electrostatic confinement fusion, which can meet the requirements of reactor ignition, nuclear material detection and nondestructive detection of aerospace components for miniaturized neutron generators.

### BRIEF DESCRIPTION OF THE DRAWINGS

FIG. 1 is a schematic diagram of an overall structure according to the present disclosure;

FIG. 2 is a schematic structural diagram of a high-voltage connector assembly according to the present disclosure;

FIG. 3 is a neutron energy spectrum distribution diagram according to the present disclosure; and

FIG. 4 is a distribution diagram of neutron angular yield according to the present disclosure.

### REFERENCE NUMERALS AND DENOTATIONS THEREOF

1—housing; 2—grid anode; 3—grid cathode; 4—molecular pump interface; 5—observation window; 6—vacuum gauge interface; 7—low-pressure cavity; 8—air inlet; 9—high-voltage connector assembly; 901—ceramic insulating ring; 902—high-voltage cable; 903—cooling pipe; and 904—stainless steel flange.

### DETAILED DESCRIPTION

In order to achieve the above objective and effect, features and functions of the technical means and structure adopted by the present disclosure will be described in detail with reference to the attached drawings of the preferred example of the present disclosure.

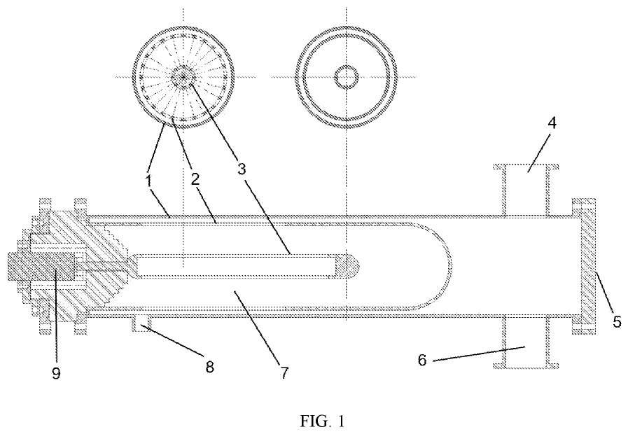

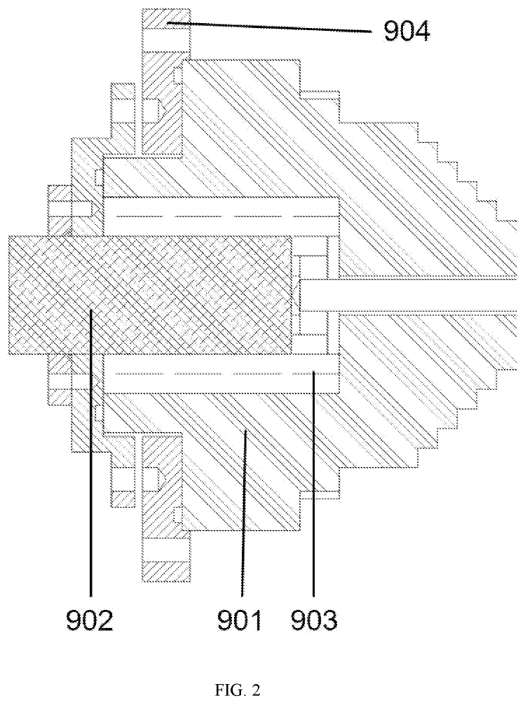

As shown in FIGS. 1-2, the present disclosure provides a coaxial cylindrical D-D neutron generator based on inertial electrostatic confinement fusion, including a housing 1, a grid anode 2, a grid cathode 3, a high-voltage connector assembly 9 and an observation window 5. One end of the housing 1 is connected to the high-voltage connector assembly 9, and the observation window 5 is arranged at the other end of the housing 1; and a low-pressure cavity 7 is arranged at an interior of the housing 1, the grid anode 2 and the grid cathode 3 are mounted in the low-pressure cavity 7, the grid anode 2 is grounded, the grid cathode 3 is electrically connected to a high-voltage power supply through a high-voltage connector, and an interior of the low-pressure cavity 7 is filled with deuterium gas, with an intensity of pressure lower than 3 Pa. A molecular pump interface 4 is arranged on the housing 1 and connected to a molecular pump through a loose flange for pumping air in the low-pressure cavity 7. A vacuum gauge interface 6 is arranged on the housing 1 and connected to a vacuum gauge through the loose flange for measuring a vacuum degree in the low-pressure cavity 7. An air inlet 8 is arranged on the housing 1, a pipe communicating with a deuterium gas source is arranged at the air inlet 8, and the deuterium gas source can be a deuterium gas cylinder. A flow valve is arranged on the pipe and electrically connected to a flow controller for accurately controlling the air intake amount.

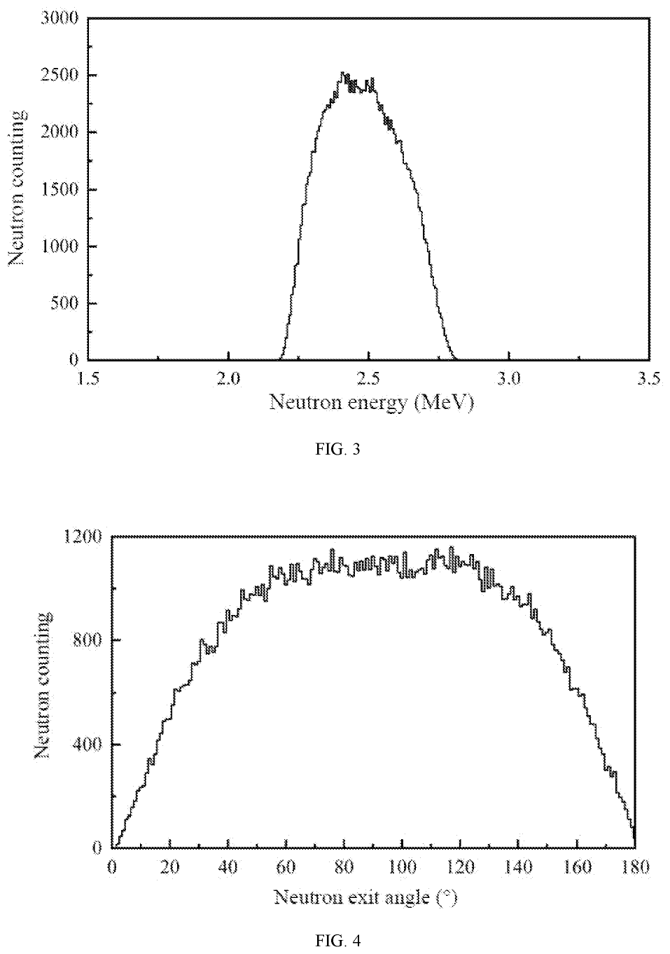

According to the present disclosure, the grid anode 2 is grounded, the grid cathode 3 is connected to the high-voltage power supply through a high-voltage cable 902 in the high-voltage connector assembly 9. The high-voltage power supply can provide with a negative high voltage of −100 kV, and a strong electric field directed to the grid cathode 3 will be generated between the grid anode 2 and the grid cathode 3. Under the action of the strong electric field, the deuterium gas in the low-pressure cavity 7 will occur glow discharge, the glow discharge phenomenon can be observed through the observation window 5, and plasma will be generated during the glow discharge. D+ ions accelerate the movement towards the grid cathode 3, and the D+ ions passing through the grid cathode 3 move reversely to the grid cathode 3 region under the action of a reverse electric field, so that a high-density D+ ion region is formed around the grid cathode 3. D+ ions interact with D+ ions to produce a D (d, n) ³He (D-D) fusion reaction, releasing D-D fast neutrons with energy of 2.2-2.8 MeV. The neutron energy spectrum is shown in FIG. 3, and the neutron angular yield distribution is shown in FIG. 4.

The housing is the stainless steel housing 1, which has a cylindrical structure and is connected to the ground wire to ensure the high-voltage safety in the laboratory and industrial application site. The high-voltage connector assembly 9, the observation window 5, the molecular pump interface 4, the vacuum gauge interface 6 and the air inlet 8 all realize the vacuum sealing with the stainless steel housing 1 through O-shaped rubber sealing rings. The stainless steel housing 1 provides a low-pressure environment for the system, and the interior of the low-pressure cavity 7 is filled with the deuterium gas.

Further, the housing has a length of 600 mm, an outer wall diameter of 110 mm, and a wall thickness of 3 mm.

In the example, the grid anode 2 is annularly arranged on a disc with a radius of 45.5 mm by 24 stainless steel columns, and each of the stainless steel columns has a length of 300 mm and a diameter of 3 mm. The grid cathode 3 is annularly arranged on a disc with a radius of 11.5 mm by 12 stainless steel columns, and each of the stainless steel columns has a length of 200 mm and a diameter of 3 mm. The grid anode 2 and the grid cathode 3 are all composed of a certain number of stainless steel columns, which are annularly arranged on discs with certain radiuses. The grid anode 2 is grounded, and the grid cathode 3 is connected to negative high voltage. In order to avoid tip discharge, column heads of the grid cathode 3, column tails of the grid cathode 3 and column tails of the grid anode 2 are of hemispherical structures. Under the action of a strong electric field, the grid anode 2 and the grid cathode 3 discharge and generate plasma. D+ ions accelerate the movement towards the grid cathode 3, and the D+ ions passing through the grid cathode 3 move reversely to the grid cathode 3 region under the action of a reverse electric field, so that a high-density D+ ion region is formed around the grid cathode 3. D+ ions interact with D+ ions to produce a D (d, n) ³He (D-D) fusion reaction, releasing neutrons.

In the example, the observation window 5 is made of silica glass with a thickness of 10 mm, and has a diameter of 110 mm. The purpose of opening the observation window 5 is to facilitate the observation of the glow emitted during the glow discharge inside the apparatus.

In the example, the high-voltage connector assembly 9 includes a ceramic insulating ring 901, a high-voltage cable 902, cooling pipes 903 and stainless steel flanges 904. The high-voltage cable 902 is configured to feed negative high voltage to the grid cathode 3, the cooling pipes 903 are wrapped around the high-voltage cable, the serrated ceramic insulating ring 901 is wrapped around the cooling pipes 903, and the stainless steel flanges 904 are mounted outside the ceramic insulating ring 901. In order to ensure the high-voltage insulation performance of the interior of the high-voltage connector, the sealed cavity in the connector is filled with transformer oil.

The present disclosure provides a coaxial cylindrical D-D neutron generator based on inertial electrostatic confinement fusion. The high-density D+ ion region is formed around the grid cathode by glow discharge, and D+ ions interact with D+ ions to generate a D (d, n)³He (D-D) fusion reaction, thus generating the high-yield fast neutron field. Because the apparatus has no target structure and no cooling system, the apparatus has the advantages of simple structure, long service life, simple maintenance and low cost. The present disclosure relates to a coaxial cylindrical D-D neutron generator based on inertial electrostatic confinement fusion, which can meet the requirements of reactor ignition, nuclear material detection and nondestructive detection of aerospace components for miniaturized neutron generators.

The working principles of the present disclosure are as follows.

The air inlet 8 is sealed and vacuumized through the molecular pump interface 4, and gas washing operations are carried out for many times to ensure that there is no residual impurity gas in the low-pressure cavity 7; and the deuterium gas is filled into the low-pressure cavity 7 through the air inlet 8, and its pressure is pumped to below 3 Pa by the molecular pump. The stainless steel housing 1 is grounded, which can ensure the high-voltage safety in the laboratory and industrial application site. When the negative high voltage of −100 kV is applied to the grid cathode 3 and the grid anode 2 is grounded, the strong electric field directed to the grid cathode 3 will be generated between the grid anode 2 and the grid cathode 3. Under the action of the strong electric field, the deuterium gas will occur glow discharge and generate plasma. The D+ ions accelerate the movement towards the grid cathode 3 under the action of the electric field, and the D+ ions passing through the grid cathode 3 move reversely to the grid cathode 3 region under the action of the reverse electric field, so that the high-density D+ ion region is formed around the grid cathode 3. D+ ions interact with D+ ions to produce a D (d, n)³He (D-D) fusion reaction, releasing D-D fast neutrons with energy of 2.2-2.8 MeV.

The above is only the preferred example of the present disclosure, and does not limit the technical scope of the present disclosure. Therefore, any slight amendment, equivalent change and modification made to the above example according to the technical essence of the present disclosure still fall within the scope of the technical solution of the present disclosure.

1. A coaxial cylindrical D-D neutron generator based on inertial electrostatic confinement fusion, comprising a housing, a grid anode, a grid cathode, a high-voltage connector assembly and an observation window, wherein one end of the housing is connected to the high-voltage connector assembly, and the observation window is arranged at the other end of the housing; and a low-pressure cavity is arranged at an interior of the housing, the grid anode and the grid cathode are mounted in the low-pressure cavity, the grid anode is grounded, the grid cathode is electrically connected to a high-voltage power supply through a high-voltage connector, and an interior of the low-pressure cavity is filled with deuterium gas.

2. The coaxial cylindrical D-D neutron generator based on inertial electrostatic confinement fusion according to claim 1, wherein a molecular pump interface is arranged on the housing and connected to a molecular pump through a loose flange for pumping air in the low-pressure cavity.

3. The coaxial cylindrical D-D neutron generator based on inertial electrostatic confinement fusion according to claim 1, wherein a vacuum gauge interface is arranged on the housing and connected to a vacuum gauge through the loose flange for measuring a vacuum degree in the low-pressure cavity.

4. The coaxial cylindrical D-D neutron generator based on inertial electrostatic confinement fusion according to claim 2, wherein a vacuum gauge interface is arranged on the housing and connected to a vacuum gauge through the loose flange for measuring a vacuum degree in the low-pressure cavity.

5. The coaxial cylindrical D-D neutron generator based on inertial electrostatic confinement fusion according to claim 3, wherein an air inlet is arranged on the housing, and a pipe communicating with a deuterium gas source is arranged at the air inlet.

6. The coaxial cylindrical D-D neutron generator based on inertial electrostatic confinement fusion according to claim 4, wherein a flow valve is arranged on the pipe and electrically connected to a flow controller for accurately controlling the air intake amount.

7. The coaxial cylindrical D-D neutron generator based on inertial electrostatic confinement fusion according to claim 1, wherein the housing has a length of 600 mm, an outer wall diameter of 110 mm, and a wall thickness of 3 mm.

8. The coaxial cylindrical D-D neutron generator based on inertial electrostatic confinement fusion according to claim 1, wherein the grid anode is annularly arranged on a disc with a radius of 45.5 mm by 24 stainless steel columns, and each of the stainless steel columns has a length of 300 mm and a diameter of 3 mm.

9. The coaxial cylindrical D-D neutron generator based on inertial electrostatic confinement fusion according to claim 1, wherein the grid cathode is annularly arranged on a disc with a radius of 11.5 mm by 12 stainless steel columns, and each of the stainless steel columns has a length of 200 mm and a diameter of 3 mm.

10. The coaxial cylindrical D-D neutron generator based on inertial electrostatic confinement fusion according to claim 7, wherein the grid cathode is annularly arranged on a disc with a radius of 11.5 mm by 12 stainless steel columns, and each of the stainless steel columns has a length of 200 mm and a diameter of 3 mm.

11. The coaxial cylindrical D-D neutron generator based on inertial electrostatic confinement fusion according to claim 1, wherein the high-voltage connector assembly comprises a ceramic insulating ring, a high-voltage cable, cooling pipes and stainless steel flanges, the high-voltage cable being configured to feed negative high voltage to the grid cathode, the cooling pipes being wrapped around the high-voltage cable, the ceramic insulating ring being wrapped around the cooling pipes, and the stainless steel flanges being mounted outside the ceramic insulating ring.
